(19) United States
(12) Patent Application Publication
(10) Pub. No.: US 2007/0018132 A1
(43) Pub. Date: Jan. 25, 2007

(54) Multi-pitch threaded coupling

(76) Inventors: Douglas Paul Gethmann, Gladbrook, IA (US); Michael Melvin Anderson, Marshalltown, IA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/187,420

(22) Filed: Jul. 22, 2005

(51) Int. Cl. F16K 27/00

(52) U.S. Cl. 251/366

(57) ABSTRACT

A multi-pitch threaded coupling for joining threaded components is disclosed. An example coupling includes a body portion having an aperture therethrough. A first end of the aperture has first threads with a first thread pitch and a second end of the aperture opposite the first end has second threads with a second thread pitch different from the first thread pitch.

### FIELD OF THE DISCLOSURE

The present disclosure relates generally to a coupling for joining threaded components and, more specifically, to a coupling having opposing threaded apertures with different thread pitches to join threaded components such as, for example, a valve body and bonnet assembly.

### BACKGROUND

Process control plants often employ sliding stem type valves to control the flow and/or pressure of process fluids. A sliding stem valve typically includes a valve stem that extends from the body of the valve and which is coupled to an actuator. In general, the actuator (e.g., a pneumatic actuator, an electric actuator, a hydraulic actuator, etc.) is responsive to a controller to stroke the valve stem (e.g., by moving the valve stem toward/away from the valve body) to vary an amount or pressure of a process fluid flowing through the valve. Also, generally, a bonnet assembly is used to guide and sealingly couple the valve trim (e.g., the valve plug) to the valve body. Additionally, the bonnet assembly may include an integral yoke or, alternatively, may be coupled to a yoke assembly that couples the actuator to the bonnet assembly.

For some types of process control plants, such as plants that process oil and gas, it is desirable to provide control valve assemblies that enable relatively quick replacement of valve trim without requiring shut down of the process control plant. To facilitate such quick replacement of valve trim, some known valve assemblies utilize a hammer nut or union to couple the valve bonnet assembly to the valve body. In general, known hammer nuts include a single internally threaded portion and are configured to slide over a tube having a flanged end. The component to which the tube having the flanged end is to be coupled includes external threads for engaging the internally threaded portion of the hammer nut. The hammer nut or union typically slides over tube having the flanged end so that the nut is threadingly engaged with the external threads of the mating component, the flange is drawn into engagement with an end of the mating component. Thus, in the case where a hammer nut is used to couple a bonnet assembly to a valve body, the bonnet assembly includes a flanged portion and the valve body includes external threads for engaging the hammer nut. With the valve actuator removed, the hammer nut can be slid over the flanged tube portion of the bonnet assembly and then tightened against the valve body to couple the bonnet assembly to the valve body. Once the hammer nut is placed over the flanged tube of the bonnet assembly, the actuator can be attached to the yoke portion of the bonnet assembly.

Although a welded connection between the actuator casing and the yoke is preferable, to facilitate painting of the valve assembly components and/or field replacement of the hammer nut and/or other valve components (e.g., valve trim), the valve actuator or diaphragm casing is typically bolted to the bonnet assembly. In this manner, the hammer nut can be placed over the bonnet assembly after the bonnet assembly is painted, the hammer nut can be tightened to couple the yoke to the valve body, and then the actuator can be bolted to the yoke. However, such bolted connections between the actuator and the yoke are undesirable because they require additional bolts, washers, etc.

### BRIEF DESCRIPTION OF THE DRAWINGS

FIG. 1 is partially cross-sectional view of known a valve assembly that uses a known hammer nut coupling to couple a bonnet assembly to a valve body.

FIG. 2 is a partially cross-sectional view of a valve assembly that uses an example multi-pitch threaded coupling to couple a bonnet assembly to a valve body.

FIG. 3 is a cross-sectional view that generally depicts example externally threaded components that may be coupled using the example multi-pitch threaded coupling described herein.

### SUMMARY

In one example embodiment, a coupling for joining threaded components includes a body portion having an aperture therethrough. A first end of the aperture has first threads with a first thread pitch and a second end of the aperture opposite the first end has second threads with a second thread pitch different from the first thread pitch.

In another example embodiment, a valve assembly includes a valve body having a first opening configured to receive a bonnet assembly and having first threads with a first pitch on an outer surface of the valve body and surrounding the first opening. The valve assembly also includes a bonnet assembly having an end configured to sealingly engage the valve body and second threads with a second pitch different from the first pitch on an outer surface of the bonnet assembly at the end of the bonnet assembly. Additionally, the valve assembly includes a coupling having a substantially cylindrical passage therethrough. A first end of the passage includes third threads to threadingly engage the first threads, and a second end of the passage includes fourth threads to threadingly engage the second threads.

### DETAILED DESCRIPTION

The example multi-pitch threaded coupling described herein facilitates the coupling of externally threaded substantially cylindrical components. More specifically, the example multi-pitch threaded coupling described herein includes opposing threaded apertures, each of which includes threads having a different thread pitch and the same threading direction (e.g., right-hand or left-hand threads). In particular, one of the threaded apertures may have threads of a first thread pitch that is relatively small or fine and the other one of the threaded apertures may have threads of a second pitch that is relatively large or coarse. As described in greater detail below, the use of different thread pitches enables the example multi-pitch threaded coupling to be rotated to threadingly disengage from an externally threaded component at slower rate than the threaded coupling threadingly engages another externally threaded component. As a result of the different rates of disengagement and engagement, the externally threaded components are drawn toward one another and, if desired, may be brought into engagement or contact with one another.

Generally, in use, a first end of the example multi-pitch threaded coupling described herein may, for example, be threaded onto a first externally threaded substantially cylindrical component having a first thread pitch (e.g., a relatively small or fine thread pitch). A second externally threaded substantially cylindrical component, which has a second thread pitch that is greater or coarser than the first thread pitch, may then be placed adjacent to the second end of the coupling. Then, as the coupling is rotated in a direction that removes it from the first component, the second end of the coupling engages and is threaded onto the second component. However, because the thread pitch of the first end of the coupling and the first threaded component is smaller or finer than the thread pitch of the second end of the coupling and the second threaded component, the coupling is threaded onto the second component at a faster rate than it is removed from the first component. As a result, the first and second components are drawn together, thereby enabling the coupling to be rotated until, for example, the first and second components are in contact, engaged, and/or sealingly engaged.

described in greater detail below, the example multi-pitch threaded coupling described herein may be advantageously used, for example, with a sliding stem valve assembly to couple the valve bonnet assembly to the valve body. When used in such a manner, a first end of the example coupling may be threaded onto an externally threaded end of the bonnet assembly (i.e., the end of the bonnet assembly to be sealingly engaged with or coupled to the valve body) with the actuator (i.e., the actuator casing) attached to the other end of the bonnet assembly (e.g., a yoke portion of the bonnet assembly). The bonnet assembly with its attached actuator and example multi-pitch threaded coupling can be mounted to the valve body. In particular, the second end of the threaded coupling is threadingly engaged with the externally threaded portion of the valve body and the threaded coupling is rotated in a direction that causes the coupling to move away from (i.e., to be threaded off of) the bonnet assembly and toward (i.e., to be threaded onto) the valve body. However, because the thread pitch of the threads on the end of the bonnet assembly is smaller or finer than the thread pitch of the threads on the valve body, the bonnet assembly and the valve body are drawn together and, ultimately, as the coupling is rotated further the bonnet assembly is drawn into engagement with (e.g., sealed against) the valve body.

Thus, in contrast to some known hammer nuts or unions, the example multi-pitch threaded coupling described herein enables an actuator to be coupled (e.g., welded) to a valve bonnet assembly (e.g., a yoke portion of the bonnet assembly) and painted prior to attachment of the bonnet/actuator assembly to the valve body. Additionally, as described in greater detail below, when the example multi-pitch threaded coupling described herein is rotated in a direction that removes it from the valve body, the bonnet assembly and valve body separate to relieve any pressure accumulated therein while both the bonnet assembly and the valve body are threadingly engaged with the threaded coupling. Separation of the bonnet assembly from the valve body while the bonnet assembly and the valve body remain captured by the threads of the coupling eliminates the need for jack pins or the like, which are typically used to separate the bonnet assembly from the valve body as a hammer nut is loosened (i.e., removed from the valve body), while enabling safe field removal of the bonnet assembly from the valve body.

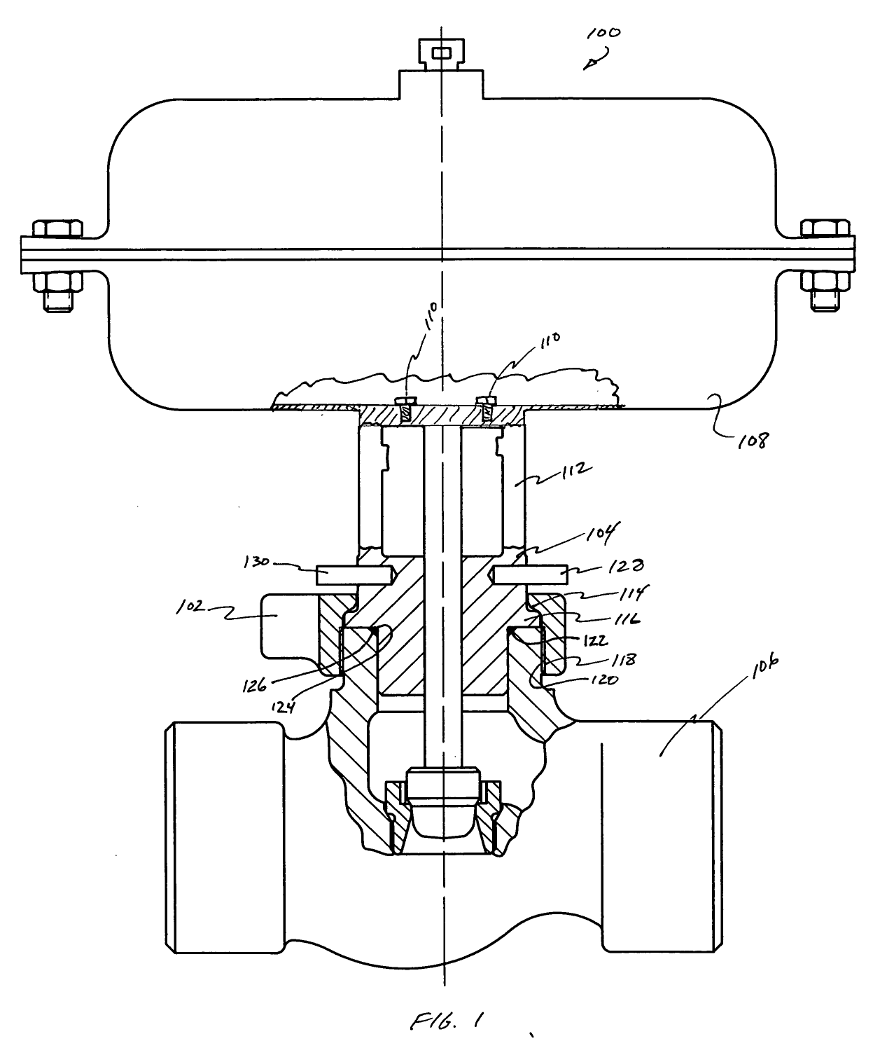

FIG. 1 depicts a partially cross-sectional view of known a valve assembly 100 that uses a known hammer nut 102 to couple a bonnet assembly 104 to a valve body 106. As depicted in FIG. 1, an actuator casing 108 is attached via bolts 110 to a yoke portion 112 of the bonnet assembly 104. The use of the bolts 110 enables the actuator casing 108 to be mounted to the yoke 112 after the hammer nut 102 is placed over and slid along the bonnet assembly 104 so that a lip or inner edge 114 of the hammer nut 102 engages or contacts a flange 116 of the bonnet assembly 104.

The hammer nut 102 includes an internally threaded portion 118 that is configured to threadingly engage an externally threaded portion 120 of the valve body 106. Thus, as the hammer nut 102 is threaded onto the valve body 106, the lip 114 of the hammer nut 102 pulls the flange 116 toward and into a sealed engagement with the valve body 106. To provide improved sealing between the bonnet assembly 104 and the valve body 106, an o-ring 122 may be disposed between an inner edge 124 of the bonnet assembly 104 and a tapered edge 126 of the valve body 104.

The valve assembly 100 may also include roll or jack pins 128 and 130 to facilitate removal of the bonnet assembly 104 from the valve body 106. In particular, to remove bonnet assembly 104 from the valve body 106, the hammer nut 102 is rotated (e.g., counterclockwise) so that the lip 114 of the hammer nut 102 moves away from the flange 116. However, there may be a significant amount of friction between the bonnet assembly 104 and the valve body 106 such that the bonnet assembly 104 remains in the valve body 106 when the lip 114 is spaced from the flange 116. Such a condition can make servicing the valve assembly 100 difficult and/or dangerous in situations where the bonnet assembly 104 is being removed for field servicing (e.g., to replace or otherwise service valve trim or other components).

Specifically, friction, which may be a result of corrosion, thermal expansion or contraction, etc., between the bonnet assembly 104 and the valve body 106 may make it difficult to remove (e.g., pull) the bonnet assembly 104 out of the valve body 106. Further, the use of hammers, pry bars, and/or other special pulling tools is undesirable from the viewpoint of a service technician. Still further, the valve body 106 may contain pressurized process fluid and, if the hammer nut 102 is rotated sufficiently to cause the threads 118 of the hammer nut 102 to completely disengage from the threads 120 of the valve body106, pressurized process fluid within the valve body 106 may cause the bonnet assembly 104 to be suddenly and forcefully expelled from the valve body 106. If the bonnet assembly 104 is suddenly and forcefully expelled in such a manner, a field service technician servicing the valve assembly 100 may be injured and/or equipment could be damaged.

To facilitate removal of the bonnet assembly 104 from the valve body 106 and to reduce or eliminate the possibility of a dangerous and sudden expulsion of the bonnet assembly 104 from the valve body 106 during removal of the bonnet assembly 104, the jack pins 128 and 130 are positioned so that the hammer nut 102 contacts and pushes on the jack pins 128 and 130 to drive the bonnet assembly 104 away from the valve body 106 before the threads 118 have completely disengaged from the threads 120. In this manner, loosening the hammer nut 102 causes the bonnet assembly 104 to be pushed out of engagement with the valve body 106 and enables any pressure built up within the valve body 106 to escape from the valve body 106 while at least some of the threads 118 of the hammer nut 102 are engaged with the threads 120 of the valve body 106.

can be appreciated from the example known valve assembly 100 shown in FIG. 1, the hammer nut 102 must placed on the bonnet assembly 104 before the actuator casing 108 is mounted to the bonnet assembly 104. Thus, if it is desirable to paint the exposed portions of the bonnet assembly 104 and/or the actuator casing 108, any such painting operation must typically be performed on the separate components (i.e., the actuator casing 108 and the bonnet assembly 104) prior to their assembly. Painting the components 104 and 108 prior to their assembly enables the components to be painted without having the hammer nut 102 on the bonnet assembly 104. Painting the actuator casing 108 and/or the bonnet assembly 104 with the hammer nut 102 on the bonnet assembly 104 would be very difficult, if not impossible, because the hammer nut 102 would have to be moved repeatedly to enable the bonnet assembly 104 to be fully painted and then the hammer nut 102 would have to be held for some time in a position in which it did not contact any wet paint on the bonnet assembly 104.

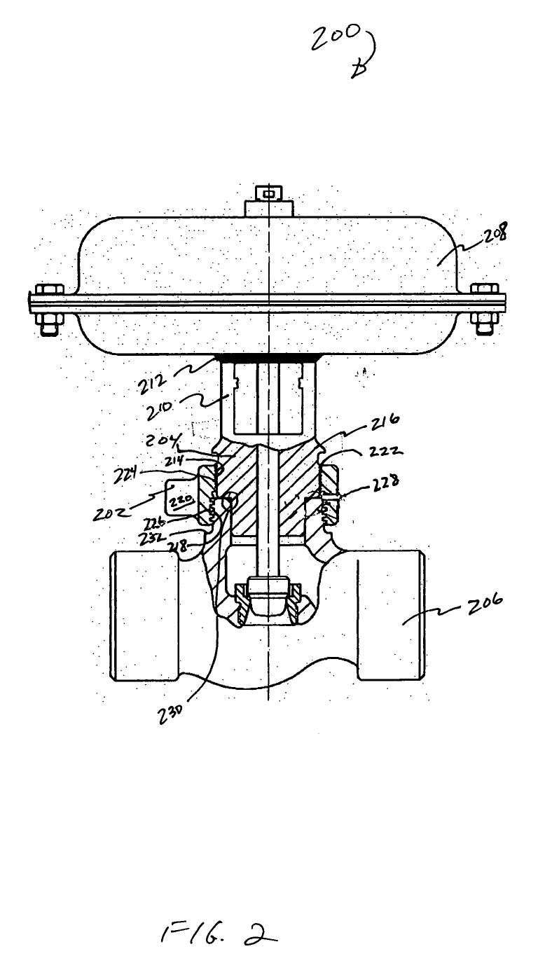

FIG. 2 is a partially cross-sectional view of a valve assembly 200 that uses an example multi-pitch threaded coupling 202 to couple a bonnet assembly 204 to a valve body 206. As depicted in FIG. 2, an actuator casing 208 is coupled to a yoke portion 210 of the bonnet assembly 204 via a weld 212. Thus, in contrast to the actuator assembly 100 of FIG. 1, the actuator casing 208 is permanently attached to the bonnet assembly 204 via the weld 212 instead of via bolts or other removable mechanical fasteners. Also, in contrast to the bonnet assembly 104 of FIG. 1, the bonnet assembly 204 includes an externally threaded portion 214 and an integral stop 216. The valve body 206 and an externally threaded portion 218 of the valve body 206 are similar or identical to the valve body 106 and the externally threaded portion 120 of FIG. 1, respectively.

The example coupling 202 includes a body portion 220 having an aperture 222 therethrough. A first end of the aperture 222 is threaded to have first threads 224 with a first thread pitch and a second end of the aperture 222 opposite the first end is threaded to have second threads 226 with a second thread pitch different from the first thread pitch. For example, the first thread pitch may be smaller or finer than the second thread pitch. In one example implementation, the second thread pitch is about twice the first thread pitch. In the example of FIG. 2, the threads 224 and 226 have the same threading direction. For example, the threads 224 and 226 may both be right-hand threads or, alternatively, may both be left-hand threads. Additionally, the threads 224 and 226 may be different thread types. For example, one of the first and second threads 224 and 226 may be an ACME thread type and the other one of the first and second threads may be an ASME thread type.

The example coupling 202 of FIG. 2 may also include a second aperture 228 that extends from an inner surface of the body portion 220 to an outer surface of the body portion 220. The second aperture 228 is configured to function as a vent to relieve pressure from the aperture of the body portion 220, particularly when the coupling is rotated to remove the bonnet assembly 204 from the valve body 206.

The example valve assembly 200 may further include a tapered metal-to-metal seal 230 to provide a seal between the bonnet assembly 204 and the valve body 206. Alternatively, any other type of seal configuration, materials, etc. may be used instead. For example, an o-ring seal such as that shown in FIG. 1 may be used to seal the bonnet assembly 204 to the valve body 206. The valve body 206 also includes a stop 232 to prevent the coupling from moving too far along the external threads 218 of the valve body 206.

While the example coupling 202 depicted in FIG. 2 is configured to function as a hammer nut or union for use with a valve assembly, the example coupling 202 may, alternatively, be configured in other manners for use in other applications. More generally, the example coupling 202 may be configured to join, couple, or attach substantially cylindrical externally threaded components.

In use, the example coupling 202 is preferably threaded onto the threads 214 of the bonnet assembly 204 after the actuator casing 208 has been welded to the yoke 210 and after the actuator casing 208 and bonnet assembly 204 have been painted. Preferably, but not necessarily, the coupling 202 is threaded (e.g., rotated counterclockwise in the orientation shown in FIG. 2) onto the bonnet assembly 204 until the coupling 202 contacts the stop 216. The bonnet assembly 204 is then placed on the valve body 206 and the coupling 202 is rotated (e.g., clockwise rotation) so that the coupling 202 moves toward the valve body 206 and so that the threads 226 engage the threads 218. Due to the relatively smaller pitch of the threads 214, 224 in comparison to the threads 218, 226, rotation of the coupling 202 (e.g., clockwise), causes the coupling 202 to thread onto the valve body 206 at a greater rate than it threads off the bonnet assembly 204. As a result, the bonnet assembly 204 and the valve body 206 are drawn together and, ultimately, into sealing engagement via the tapered seal 230. The stop 232 prevents the coupling 202 from being rotated too far such that too few or none of the threads 224 remain engaged with the threads 214. Having too few of the threads 224 and 214 engaged may result in a weak, failure prone connection between the bonnet assembly 204 and the valve body 206.

To remove the bonnet assembly 204 from the valve body 206, the coupling 202 is rotated in a removal direction (e.g., counterclockwise) so that the coupling 202 threads off of the valve body 206 and onto the bonnet assembly 204. Due to the difference in the pitches of the threads 214, 224 and 218, 226, the bonnet assembly 204 and the valve body 206 separate and move away from one another as the coupling is rotated in the removal direction. Thus, jack pins (such as those shown in FIG. 1) or the like are not needed to facilitate the safe separation of the bonnet assembly 204 from the valve body 206. Additionally, for increased safety, the aperture 228 facilitates the venting of pressure from the valve body 206 to atmosphere during the removal process.

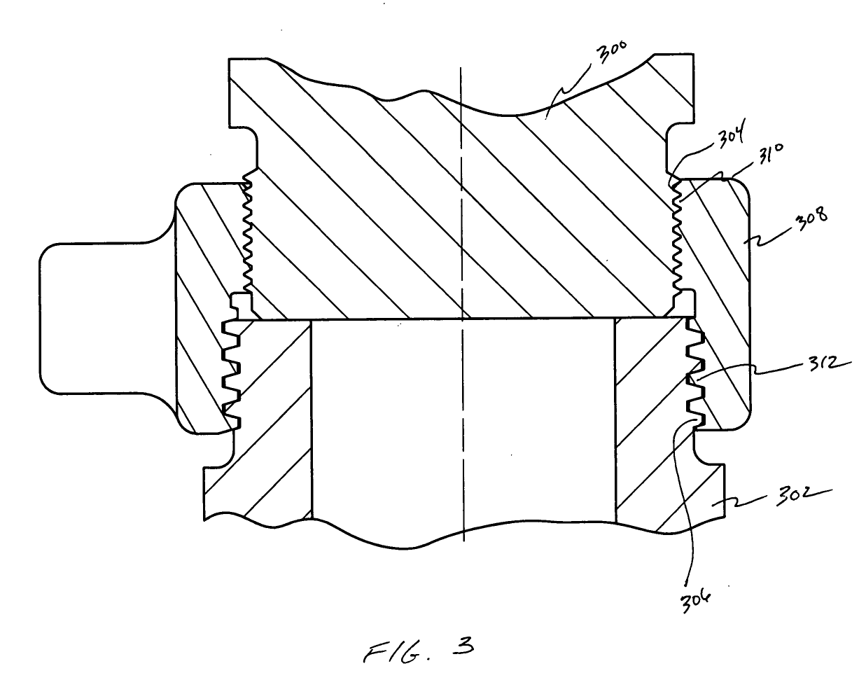

FIG. 3 is a cross-sectional view that generally depicts example externally threaded components 300 and 302 that may be coupled using the example multi-pitch threaded coupling described herein. As depicted in FIG. 3, the externally threaded component 300 has threads 304 of a relatively fine or small pitch, and the externally threaded component 302 has threads 306 of a relatively coarse or large pitch (i.e., a pitch that is greater than that of the threads 304). An example multi-pitch threaded coupling has threads 310 that engage with the threads 304 of the component 300 and threads 312 that engage with the threads 306 of the component 302. The threads 304, 306, 310, and 312 all have the same threading direction and, thus, are all either right-hand threads or left-hand threads. As a result, rotation of the coupling 308 in one direction causes the components 300 and 302 to be drawn together within the coupling 308 and rotation in the other direction cause the components 300 and 302 to be pushed apart and away from the coupling 308.

Although certain apparatus, methods, and articles of manufacture have been described herein, the scope of coverage of this patent is not limited thereto. To the contrary, this patent covers all embodiments fairly falling within the scope of the appended claims either literally or under the doctrine of equivalents.

What is claimed is:

1. A coupling for joining threaded components, comprising:
a body portion having an aperture therethrough, wherein a first end of the aperture has first threads with a first thread pitch and a second end of the aperture opposite the first end has second threads with a second thread pitch different from the first thread pitch.

2. A coupling as defined in claim 1, wherein the first and second threads have the same threading direction.

3. A coupling as defined in claim 1, wherein the body portion is configured as a hammer nut.

4. A coupling as defined in claim 1, wherein the first and second threads are different thread types.

5. A coupling as defined in claim 4, wherein one of the first and second threads is an ACME thread type and the other one of the first and second threads is an ASME thread type.

6. A coupling as defined in claim 1, wherein the first thread pitch is about twice that of the second thread pitch.

7. A coupling as defined in claim 1, further comprising a second aperture extending from an inner surface of the body portion to an outer surface of the body portion.

8. A coupling as defined in claim 1, further comprising a vent configured to relieve pressure from the aperture of the body portion.

9. A valve assembly, comprising:
a valve body having a first opening configured to receive a bonnet assembly and having first threads with a first pitch on an outer surface of the valve body and surrounding the first opening;
a bonnet assembly having an end configured to sealingly engage the valve body and second threads with a second pitch different from the first pitch on an outer surface of the bonnet assembly at the end of the bonnet assembly; and
a coupling having a substantially cylindrical passage therethrough, wherein a first end of the passage includes third threads to threadingly engage the first threads, and wherein a second end of the passage includes fourth threads to threadingly engage the second threads.

10. A valve assembly as defined in claim 9, wherein the first and second threads have the same threading direction.

11. A valve assembly as defined in claim 9, wherein the coupling is configured as a hammer nut.

12. A valve assembly as defined in claim 9, wherein the first and second threads are different thread types.

13. A valve assembly as defined in claim 12, wherein one of the first and second threads is an ACME thread type and the other one of the first and second threads is an ASME thread type.

14. A valve assembly as defined in claim 9, wherein the first thread pitch is about twice that of the second thread pitch.

15. A valve assembly as defined in claim 9, further comprising a second aperture extending from an inner surface of the coupling to an outer surface of the coupling.

16. A valve assembly as defined in claim 9, further comprising a vent configured to relieve pressure from the substantially cylindrical passage.

17. A valve assembly as defined in claim 9, wherein the bonnet assembly and the valve body include a tapered seal to enable the bonnet assembly to sealingly engage the valve body.

18. A valve assembly as defined in claim 17, wherein the tapered seal is a metal-to-metal seal.

19. A valve assembly as defined in claim 9, wherein the valve body comprises a stop to limit the travel of the coupling along the first threads.

20. A valve assembly as defined in claim 9, wherein the bonnet assembly comprises a stop to limit the travel of the coupling along the second threads.
